(19) United States
(12) Patent Application Publication
(10) Pub. No.: US 2008/0227889 A1
(43) Pub. Date: Sep. 18, 2008

(54) Flame-Resistant Amino Resin System

(75) Inventors: Markus Machherndl, Leonding (AT); Christian Furst, Linz (AT); Sascha Kaltenbacher, Linz (AT); Siegfried Schmidtberger, Linz (AT)

Correspondence Address: THE WEBB LAW FIRM, P.C., 700 KOPPERS BUILDING, 436 SEVENTH AVENUE, PITTSBURGH, PA, 15219, US

(73) Assignee: AMI AGROLINZ MELAMINE INTERNATIONAL GMBH, Linz (AT)

(21) Appl. No.: 10/586,375

(22) PCT Filed: Jan. 28, 2005
(86) PCT No.: PCT/EP2005/000992

§ 371 Date: Feb. 11, 2008

(30) Foreign Application Priority Data
Jan. 30, 2004 (DE) 10 2004 006 068.1

(51) Int. Cl. C08K 9/10

(52) U.S. Cl. 523/208

(57) ABSTRACT

The invention relates to a flame-resistant amino resin system, in particular a melamine formaldehyde resin system, a melamine-urea formaldehyde resin system or a urea formaldehyde resin system, having: a) a modified amino resin matrix, the primary aminoplast condensation products being present at least partially in etherified form and the modified amino resin being obtained from an amino resin melt that is essentially devoid of solvent; and b) at least one compound, which acts as the flame-resistant component, contains phosphorus and/or nitrogen and/or boron in chemically bonded form and which is present in the amino resin matrix in encapsulated form. This permits the development of an amino resin system that can be thermoplastically treated, has excellent flame-resistant properties and in addition exhibits optimal curing, processing and surface characteristics.

The invention relates to a flame-resistant aminoplast resin system as claimed in claim 1, a process for the preparation thereof as claimed in claim 19 and the use thereof as claimed in claim 23 and a composite material as claimed in claim 27.

Aminoplast resins are monomolecular or low molecular weight condensates of a component containing amino, imino or amido groups, a so-called aminoplast former, with a carbonyl compound.

Among the aminoplast resins, melamine-formaldehyde and urea-formaldehyde resins are of the greatest industrial importance.

Unmodified or slightly modified aminoplast resins have the advantage that they are flame-retardant or self-extinguishing. They are therefore also used in combination with other substances in order to flameproof a very wide range of materials, such as, for example, plastics or wood.

Aminoplast resins which are modified, for example, with alcohols or polyols contain ether groups as structural units; they are designated as modified aminoplast resins. They are used in general as crosslinking agents in polymeric coating systems, as a constituent of adhesives or in the production of resistant surfaces. U.S. Pat. No. 4,985,307 discloses aqueous coating systems which contain modified aminoplast resin solutions in combination with phosphoric acid derivatives and encapsulated flame retardants and are used for the flameproofing of wood.

Owing to their small processing window and thermally unstable molecular groups, conventional unmodified or slightly modified aminoplast resins are not suitable for the customary thermoplastic processing methods, such as extrusion, injection molding or blow molding.

Aminoplast resins which have a sufficiently high melt viscosity so that they can be processed by thermoplastic methods are also known. Thus, these aminoplast resins, as described, for example, in WO 03/046053 A1, are suitable in principle for the production of shaped articles, such as sheets, pipes, profiles, fibers and the like.

Such resins are usually prepared by concentrating the modified liquid resin obtained in the resin synthesis to give a resin melt and then condensing the melt at elevated temperature in kneaders, extruders or the like.

These thermoplastically processible modified aminoplast resins have a plurality of disadvantages. One of the main disadvantages is their higher flammability compared with unmodified aminoplast resins. The use of conventional flame retardant systems is very problematic. Since these systems largely contain acidic or latently acidic constituents the curing of the resin is catalyzed simply on mixing them with the aminoplast resin. Furthermore, these flame retardant systems have low compatibility with the resin, which leads to a poor distribution and hence to inadequate flame protection.

A further disadvantage of the known thermoplastically processible aminoplast resin systems is that incompletely reacted modifiers, such as, in particular, alcohols or polyols, liberate undesired cleavage products which diffuse out of the resin during or after the curing or even during storage of the end product. In addition to the health concerns of these cleavage products, they cause foaming and considerable shrinkage during compression molding and thus adversely affect the quality of the finished aminoplast resin product in that cracks and irregularities on the surface often occur.

A further disadvantage relates to the curing of the thermoplastically processible aminoplast resins. Without a curing catalyst, the curing takes place very slowly and only at very high temperatures. The disadvantage of conventional curing catalysts is that, on direct metering of the curing agent into the resin, the catalytic effect begins at low temperature, i.e. the curing often takes place at a processing stage which is much too early. In addition, such curing agents often have low compatibility with the aminoplast resin, with the result that only a poor distribution in the resin can be achieved.

For the reasons mentioned, the modified thermoplastically processible aminoplast resin systems known to date are almost exclusively used in coating systems, where they serve as crosslinking agents. Owing to the excellent material and processing properties of these modified aminoplast resins however, the use thereof as a material, for example as a matrix resin in composite materials, would be desirable.

It was accordingly an object of the present invention to develop an aminoplast resin system which has flame-resistant properties and which does not have said disadvantages.

This object is achieved by an aminoplast resin system as claimed in claim 1.

The present invention therefore relates to a flame-resistant aminoplast resin system, in particular melamine-formaldehyde resin, melamine/urea-formaldehyde resin or urea-formaldehyde resin system, comprising
a) a modified aminoplast resin matrix, the primary aminoplast condensates being present at least partly in etherified form in the modified aminoplast resin, and the modified aminoplast resin having been obtained from a substantially solvent-free aminoplast resin melt, and
b) at least one compound which contains phosphorus and/or nitrogen and/or boron in chemically bonded form and is present in encapsulated form, in particular in a form enclosed by a capsule wall material, in the aminoplast resin matrix, as a flame-retardant component.

An advantage of the flame-resistant aminoplast resin system according to the invention is that it has greatly increased flame resistance in comparison with the known thermoplastically processible aminoplast resins.

A further advantage is that the undesired cleavage products of the aminoplast resin system according to the invention which are liberated by incompletely reacted resin modifiers, such as alcohols or polyols, during the curing can be both adsorbed and reactively bonded by the capsules and/or by the encapsulated compounds. As a result of this, the shrinkage during compression molding is minimized and a virtually crack-free smooth aminoplast resin surface is obtained.

The modified aminoplast resin matrix of the aminoplast resin system according to the invention contains at least one modified aminoplast resin.

Suitable aminoplast formers for the modified aminoplast resin are, for example, melamine, aminotriazines, urea, dicyandiamide, guanamines or substituted melamines and ureas.

Melamine or urea or mixtures of melamine and urea is or are preferably used. Melamine is particularly preferably used as an aminoplast former.

Suitable carbonyl compounds for the aminoplast resin present in the matrix are, for example, formaldehyde, acetaldehyde, isobutyraldehyde, acetone, methyl ethyl ketone, glyoxylic acid, glyoxylic acid methyl ester monoacetal or diethyl ketone.

Formaldehyde is preferably used as the carbonyl compound.

An aminoplast resin which is formed by condensation of the components formaldehyde, melamine and/or urea is particularly preferred.

The aminoplast resins have a molar ratio of aminoplast former to carbonyl compound of from 1:1.4 to 1:6, preferably from 1:1.5 to 1:4, particularly preferably from 1:1.5 to 1:3.

In the modified aminoplast resins, the primary condensates are partly or completely etherified, preferably with C₁-C₄-alcohols.

The molar ratio of carbonyl compound to C₁-C₄-alcohol in the preparation of the etherified modified aminoplast resins is in the range of from 1:2 to 1:10, preferably from 1:3 to 1:7, particularly preferably from 1:3 to 1:5.

The etherification of the aminoplast resin present in the aminoplast resin matrix can be effected in a separate second reaction step after the primary condensation of the aminoplast former with the carbonyl compound.

Advantageously, the etherification is effected in the same reaction step as the primary aminoplast condensation.

The partly or completely etherified aminoplast resin can be partly or completely transetherified in a further reaction step, the transetherification preferably being effected with aliphatic C₄-C₁₈-alcohols or aromatic alcohols, diols or polyols. Mixtures may also be used.

Examples of polyols are poly- and oligoethylene glycol derivatives, for example simulsols; oligo-, hydroxycarboxylic acid derivatives, for example caprolactone derivatives; poly- and oligoester polyols; poly- and oligolactides; sugars, sugar derivatives; starch, starch derivatives or cellulose derivatives.

The molar ratio of carbonyl compound to transetherification agent in the preparation of the transetherified modified aminoplast resins is in the range of 2:1 to 100:1, preferably from 10:1 to 70:1, particularly preferably from 20:1 to 60:1.

A modified aminoplast resin in the context of the present invention is also one which, in addition to or instead of the transetherification with alcohols, diols and polyols, is obtained, for example, by condensation or subsequent addition of other customary modifiers, such as, for example, caprolactam, sulfites, sulfonamides, carbamates, salts of maleic or fumaric acid monoamides, epoxides, bisepoxides or isocyanates. Furthermore, fillers and/or reinforcing fibers, further polymers and stabilizers, UV absorbers and/or auxiliaries may also be present in the modified aminoplast resin.

Such possible additives are described, for example, in WO 03/046053 A1.

The modified aminoplast resin characterizing the aminoplast resin matrix according to the invention is obtained from the corresponding, substantially solvent-free aminoplast resin melt.

For the aminoplast resin matrix of the aminoplast resin system according to the invention, for example, the aminoplast resins described in WO 03/046053 A1 are used.

The aminoplast resin system according to the invention contains at least one compound present in encapsulated form.

The compound present in encapsulated form contains phosphorus and/or nitrogen and/or boron in chemically bonded form. The compound is, for example, any inorganic or organic phosphorus, nitrogen and/or boron compound.

Examples of such phosphorus, nitrogen and boron compounds are ammonium, amine, melamine and aminotriazine salts of phosphoric acid, diphosphoric acid, oligophosphoric acids, metaphosphoric acids, polyphosphoric acids, phosphinic acid, phosphonic acid and diphosphonic acid; nonionic reaction products of aminotriazines, for example melamine with phosphorus pentoxide and phosphorus trioxide; phosphazenes; phosphorus nitrides PₓN_{y}; phosphorus oxynitrides POₓN_{y}; boron phosphate BPO₄; boron nitride BN; boron trioxide B₂O₃; sodium tetraborate Na₂B₄O₇; boric acid B(OH)₃; di-, oligo-, poly-, phosphoric acid esters, and their ammonium, amine, melamine and aminotriazine salts, based on the reaction of phosphorus pentoxide with diols or polyols, for example pentaerythritol or dipentaerythritol; di-, oligo-, poly-, phosphonic acid esters, and their ammonium, amine, melamine and aminotriazine salts, based on the reaction of phosphorus trioxide with diols or polyols, for example pentaerythritol or dipentaerythritol; encapsulated aminotriazines, for example melamine and mixtures, reaction products, adducts and derivatives of said compounds.

Particularly preferred encapsulated compounds are ammonium polyphosphate, melamine polyphosphate, phosphoric acid esters and phosphonic acid esters based on the reaction of phosphorus pentoxide or phosphorus trioxide with pentaerythritol or dipentaerythritol, and their ammonium and melamine salts.

In a preferred embodiment, a compound which, in addition to the flame-retardant effect, also has a proton-liberating, i.e. acidic, effect is used as a compound present in encapsulated form.

This has the advantage that such compounds in the aminoplast resin system according to the invention also serve as a curing catalyst in addition to their effect as a flame retardant. However, the acidic effect is shielded by the encapsulation to such an extent that, in contrast to unencapsulated proton-liberating compounds in the aminoplast resin matrix, no premature, undesired curing takes place. At the desired curing time, curing catalysis is achieved by a moderate reduction in pH in that the curing temperatures of the aminoplast resin systems according to the invention are lower than in the case of systems without any curing catalysts. In addition a more complete reaction of the resin modifiers with the aminoplast resin, i.e. in general more complete etherification, is achieved by the catalytic effect of encapsulated, proton-liberating compounds.

It is possible to use one or more different compounds present in encapsulated form in the aminoplast resin system according to the invention. For example, mixtures of a purely flame-retardant component, such as, for example, encapsulated boron trioxide, with a component having both an acidic and a flame-retardant effect, such as, for example, encapsulated ammonium polyphosphate, can be used.

By various combinations, synergies can be utilized, i.e. the components are reinforced in their effect by the combined use thereof.

The capsule wall material which surrounds the compound may obtain, for example, the following materials: alginates, gelatin, agar-agar, gum Arabic, latex, chitosan, aminoplast resins, phenol resins, epoxy resins, unsaturated polyester resins, polyvinyl alcohols, polyacrylates, polymethacrylates, polyacroleins, polyamides, polyethylene glycols, polyether sulfones, waxes, paraffins, cellulose derivatives, glyceryl monostearates, ethyl- and styrene-maleic anhydride copolymers and various other synthetic polymers.

It is advantageous if the capsule wall material contains a thermosetting resin, in particular an aminoplast resin, an epoxy resin, an unsaturated polyester resin or a phenol resin.

The preparation of thermosetting resin-encapsulated ammonium polyphosphate is described, for example, in DE 2949537 or in DE 3316880.

Particularly preferably, the capsule wall material contains a modified aminoplast resin. Those modified aminoplast resins which have comparable surface properties, such as, for example, hydrophilicity, hydrophobicity, to the modified aminoplast resin forming the aminoplast resin matrix are particularly preferred.

In this case, a particularly advantageous homogeneous distribution of the capsules in the aminoplast resin matrix is achieved by the very good compatibility of the capsule wall material with the matrix aminoplast resin. This results, inter alia, in excellent flame resistance of the resulting aminoplast resin system according to the invention.

Since the compound present in encapsulated form should be distributed as homogeneously as possible in the aminoplast resin matrix, it is advantageous if thorough mixing is effected during addition of the capsules to the modified aminoplast resin.

It is particularly advantageous if the ratio of the average diameter D to the average capsule wall thickness d of the capsules present in the aminoplast resin system according to the invention is from 5 to 1000. The time up to liberation of the encapsulated compound is defined by the ratio D/d. D/d>>D results in a capsule having a very small capsule wall thickness, where the active substance is released after thermal loading for a short time. D/d<D results in a capsule having a large capsule wall thickness, where the active substance is released only after thermal loading for a relatively long time.

The average diameter D of the capsules is advantageously in the range of 1-100 μm, preferably in the range of 10-60 μm, particularly preferably in the range of 20-50 μm.

The geometrical shape of the capsules may be, for example, spherical, oval or acicular, but spherical capsules are preferably used.

With spherical capsules, it is possible to achieve a particularly homogeneous distribution in the aminoplast resin.

An aminoplast resin system which contains from 0.5 to 50% by weight, preferably from 1 to 40% by weight, particularly preferably from 5 to 25% by weight, of compounds present in encapsulated form, based on the total weight of the cured aminoplast resin system, is particularly advantageous.

The amount of the compound present in the capsules is from about 50 to 98% by weight, preferably from 70 to 90% by weight, based on the total weight of a compound present in encapsulated form.

The compounds present in encapsulated form are usually present in powder form. They have a bulk density of from 200 to 1600 g/liter, preferably from 500 to 1100 g/liter. They may be added to the modified aminoplast resin as powder and/or as a suspension.

For example, water, alcohols, such as, for example, butanol or methanol, diols or polyols, such as, for example, simulsols, caprolactone derivatives, poly- and oligoester polyols or trimethylolpropane may be used as suspending agents. Relatively highly viscous, concentrated resin solutions are possible as further suspending agents.

It is particularly preferable if the compound present in encapsulated form is added in suspended form. It is particularly advantageous to use, as the suspending agent, the substantially solvent-free aminoplast resin melt and/or at least a part of the transetherification agents and/or modifiers used for modifying the aminoplast resin.

The solids content of the suspension is from about 30 to 90% by weight, preferably from about 40 to 80% by weight.

The viscosity of the suspensions is in the range of from about 10 to 5000 mPa·s, preferably from about 250 to 1000 mPa·s.

In order to obtain a pumpable and meterable suspension, the suspension can be stirred and heated.

The preparation of the aminoplast resin system according to the invention is effected in the process stages
a) preparation of a modified aminoplast resin solution or suspension in a solvent,
b) concentration of the modified aminoplast resin solution or suspension to give the modified, substantially solvent-free aminoplast resin melt,
c) reactive conversion of the modified, substantially solvent-free aminoplast resin melt at elevated temperature, for example in an extruder or kneader for pre-condensation and conditioning and
d) compounding and discharge of the flame-resistant aminoplast resin system.

The compound present in encapsulated form can be added to the modified aminoplast resin during or after each of the process stages.

For example, the compound present in encapsulated form is added in powder form during or after the synthesis of the liquid modified aminoplast resin, so that a modified aminoplast resin suspension is obtained.

A further possibility consists in adding the compound during that process step where the modified aminoplast resin is already present as a modified, substantially solvent-free aminoplast resin melt, i.e. before or during the reactive conversion.

If the compound is added in the form of a suspension, the addition is effected before or during the reactive conversion.

The addition is preferably effected during the reactive conversion in an extruder, the capsules advantageously being added after the high-temperatures pre-condensation, conditioning and reactive conversion with transetherification agents/modifiers of the modified aminoplast resin.

For example, in operation with two extruders in series, the high-temperature pre-condensation and conditioning and reactive conversion with transetherification agents and/or modifiers can be effected in the first extruder. Under moderate conditions, the compound present in encapsulated form is then compounded with the modified, substantially solvent-free aminoplast resin melt in the second extruder, further pre-condensation and conditioning and reactive conversion with transetherification agents and/or modifiers subsequently taking place under slightly acidic, catalytic conditions.

It is also possible to divide the addition of the compound present in encapsulated form between more than one process stage.

The transetherification agents and/or modifiers, too, can be added in different process steps, for example during and/or after the synthesis of the modified aminoplast resin and/or during the concentration and/or the reactive conversion.

The modifiers are added in general in an amount of 0.5-20% by weight.

The preparation of the modified aminoplast resin solution or suspension is effected in a pH range of pH=2 to pH=7, preferably of about pH=3 to pH=6.9. The temperature range is from about 40 to 160° C., preferably from about 70 to 120° C., and the pressure range from about 0 to 15 bar, preferably from about 0 to 5 bar, gage pressure. The reaction time is from about 5 to 300 minutes, preferably from about 15 to 120 minutes. The solids content of the modified aminoplast resin solution or suspension is in the range from about 15 to 60% by weight, preferably in the range from about 25 to 40% by weight.

The pH of the modified aminoplast resin solution or suspension is subsequently rendered alkaline, a pH in the range from about pH=7 to 12, preferably in the pH range of about 8-9.5, being advantageous.

The modified aminoplast resin solution or suspension is concentrated by distilling off the solvents. This is effected, for example, in stirred reactors having a distillation attachment, in thin-film evaporators or in filmtruders, preferably in thin-film evaporators. The concentration is effected in a temperature range from about 50 to 180° C., preferably from about 70 to 140° C., and in a pressure range from about −1 to 0 bar, preferably from about −0.95 to −0.5 bar, gage pressure. The residence time is from about 1 to 120 minutes, preferably from about 3 to 60 minutes.

A modified, substantially solvent-free aminoplast resin melt having a solids content of from about 95 to 100% by weight and a glass transition temperature of about 30-130° C., preferably about 60-100° C., is obtained. The viscosity of the melt is in the range from about 150 mPa·s to 100 Pa·s, preferably from about 300 mPa·s to 30 Pa·s, measured at 130° C.

The modified, substantially solvent-free aminoplast resin melt is subsequently further processed by reactive conversion at elevated temperature, for example in an extruder or kneader, for pre-condensation and conditioning.

If transetherification agents and/or modifiers were added, these apparatuses likewise serve for the compounding and establishment of a uniform distribution of these substances in the aminoplast resin, and their reactive conversion with the aminoplast resin melt is effected there.

In the pre-condensation, the molar mass of the monomeric structures is increased to give oligomeric or polymeric structures. In the conditioning, thermally unstable, readily volatile, gaseous compounds and molecular groups are eliminated from the modified aminoplast resin melt, which thus gains in storage stability.

The reactive conversion is preferably carried out in a twin-screw extruder. In order to increase the residence time, a residence time apparatus can be connected upstream.

An advantageous variant in terms of apparatus consists in operating two extruders in series.

High flexibility in relation to the position of metering in components, the reactive conversion, the pre-condensation and the conditioning is achieved thereby.

The reactive conversion is effected in a material temperature range from about 130 to 250° C., preferably from about 140 to 220° C., and in a pressure range from about −1 to 0 bar, preferably from about −0.95 to −0.1 bar, gage pressure. The residence time is from about 0.5 to 10 minutes, preferably from about 1 to 5 minutes.

After the reactive conversion of the aminoplast resin containing the encapsulated compound, said resin is compounded, for example granulated, and the flame-resistant aminoplast resin system according to the invention is discharged.

After emergence from the extruder, cooling and compounding of the aminoplast resin melt are effected.

Apparatuses such as pelletizers, granulating mills, hot face cutters or briquetting apparatuses can be used for this purpose.

The flame-resistant aminoplast resin system according to the invention is present in the form of solid granules having a particle size of about 0.2-10 mm, preferably 1-3 mm. The appearance depends on the color of the encapsulated compound or of the additives and is usually opaque white. The glass transition temperature of the flame-resistant aminoplast resin system is from about 40 to 140° C. and the melting point is from about 70° C. to 160° C. The viscosity of the aminoplast resin system according to the invention is in the range from about 5 to 100 000 Pa·s, preferably in the range from about 50 to 50 000 Pa·s, measured at 130° C.

The aminoplast resin system according to the invention can be used, for example, for the preparation of hybrid resin systems.

These can be prepared, for example, by mixing and/or chemical reaction of the aminoplast resin systems according to the invention with modified and/or unmodified melamine-formaldehyde resins, epoxy resins, polyurethane resins, unsaturated polyester resins and/or alkyd resins as melts in a kneader, mixer or extruder.

The advantage of such systems is that flame resistance of said resin systems is achieved by the compounding of these resin systems with the aminoplast resin systems according to the invention.

It is also possible further to process the flame-resistant aminoplast resin system according to the invention as compression molding resin or injection molding resin.

For compression molding materials, the aminoplast resin system according to the invention is usually used in the form of granules or powder.

The viscosity of the aminoplast resin suitable for this purpose is usually in the range from about 100 to 100 000 Pa·s, preferably in the range from about 1000 to 50 000 Pa·s, measured at 130° C.

For example, downstroke and/or upstroke molding presses are used as press tools.

The compression molding temperature is usually in the range from about 130° to 220° C., preferably from about 150° C. to 190° C. The compression pressure may be chosen in the range from about 5 bar to 250 bar and is preferably from about 50 to 200 bar. The duration of compression for a degree of curing of 90-95% is from about 120 sec to 600 sec, preferably from about 180 sec to 360 sec.

For injection molding, the flame-resistant aminoplast resin system according to the invention is fed, for example, into a screw conveyer, preferably into an extruder, in the form of granules and/or in the form of powder, melted therein and injected into the injection mold.

The viscosity of the aminoplast resin suitable for this purpose is usually in the range from about 5000 to 100 000 Pa·s, preferably in the range from about 10 000 to 50 000 Pa·s, measured at 130° C.

Conventional injection molding units can be used for this purpose. Such systems operate, for example, in a range from about 130° to 220° C., preferably from about 150° C. to 190° C. The injection pressure at the nozzle is in the range from about 500 bar to 2500 bar, preferably from about 1000 to 2000 bar. The cycle time of the injection molding for a degree of curing of 90-95% is from about 60 sec to 600 sec, preferably from about 120 sec to 300 sec.

Furthermore, it is possible to process the aminoplast resin system according to the invention with a substrate material to give a composite material.

For example, fibers, nonwovens, woven fabrics, wood and/or also polymers can be used as substrate materials. Cellulose, glass, flax and/or carbon fibers are preferably used as fibers.

For the production of the composite materials, it is possible, for example, to powder the substrate material with the aminoplast resin system according to the invention. In order to ensure as good a distribution of the resin system as possible, it may be necessary to mill the resin granules beforehand. A further possibility consists in melting the resin and drawing the substrate material through the resin melt, with the result that the resin is applied as a coating.

After the resin has been applied to the substrate material, a pre-condensation step in the range of about 110-250° C., preferably in the range of about 150-220° C., is carried out for a duration of about 1-10 minutes, the resin system in the molten state undergoing further condensation and thus being fixed on the substrate material. Storable prepregs are obtained thereby.

The content of flame-resistant aminoplast resin system according to the invention in the composite material is in the range from about 20 to 80% by weight, the actual content being dependent on the desired processing method and the required properties.

The prepregs obtained can subsequently be subjected to any desired shaping with a temperature increase.

The shaping is effected, for example, by a pressing process, such as compression molding, twin-belt pressing, 3D pressing and/or thermoforming.

In the pressing process, the curing of the resin system takes place. The degree of curing can be monitored by means of ultrasound and adjusted to the desired value.

If a latently acidic compound is encapsulated, acid is released in a metered manner during the compression molding, and the curing takes place in the acidic pH range. If the encapsulated compound has no latently acidic properties, the curing takes place under alkaline conditions. The curing can in principle take place in all pH ranges, the curing time being substantially longer in the alkaline pH range than in the acidic pH range. Thus, the curing times are from about 120 to 600 sec in the alkaline pH range and the curing times are from about 60 to 360 sec in the acidic pH range.

The composite materials are preferably cured in an acidic pH range of about pH 3-6.5. The temperatures during curing are from about 90 to 250° C., preferably from about 120 to 190° C. The duration of the curing process is from about 0.5 to 30 minutes, preferably from about 3 to 10 minutes. The compression pressure is in the range from 10 to 250 bar, preferably from about 50 to 200 bar.

If stresses form in the material as a result of the compression molding and curing, they can be eliminated by annealing. For this purpose, the samples are stored for up to about 240 hours at up to about 110° C. until the weight remains constant.

The aminoplast resin system according to the invention can be used as a flame-resistant aminoplast resin material, for example for the production of pipes, sheets, profiles, injection molded parts or fibers.

A further possible application is, for example, as curing agents or crosslinking agents in powder coating systems.

Composite materials which are produced using the resin system according to the invention can be used, for example, for the production of flame-resistant products, such as shaped articles for the automotive industry, claddings for buildings and machines, cable insulations or insulation materials.

The invention is explained below with reference to examples:

### 1 General Preparation Example for the Modified Aminoplast Resin System

### 1.1 Preparation of the Modified Aminoplast Resin Solution or Suspension

The experimental examples for the preparation of the modified aminoplast resin solution or suspension are shown in table 1.

In experiments 1 to 10, no transetherification agent was added to the etherified melamine resin.

In examples 5, 10, 11 and 15 no encapsulated compound was added and said examples serve as comparative examples.

The amounts of melamine, methanol and p-toluenesulfonic acid as the catalyst which are mentioned in the table were mixed in a stirred reactor with stirring.

Thereafter, in experiments 11, 12, 15 and 16, the transetherification agent Simulsol BPPE was added to the reaction mixture—this variant is shown in column al in table 1.

In experiments 1 and 6, the encapsulated compound in the form of Exolit AP 462 was added after the mixing of melamine, methanol and p-toluenesulfonic acid. This variant is shown in column b1 in table 1.

The mixture was then heated to the reaction temperature T_{React}. Thereafter, formalin pre-heated to about 60° C. was rapidly admixed and the reaction thus started. After the clear point (T_{Clear}) had been reached, stirring was continued at the reaction temperature as long as desired (reaction time t_{React}). Thereafter, the reaction was stopped by cooling the reaction mixture to about 30° C.

In experiments 1 and 6, no clear point is shown since the capsules are suspended in the reaction mixture. The total reaction time is therefore stated in the column t_{React}.

After cooling, the pH was adjusted to about 9.5 with KOH solution.

The result of the synthesis was a modified aminoplast resin solution or suspension in methanol/water.

In experiments 2, 7, 12 and 16, the encapsulated compound in the form of Exolit AP 462 was added to the prepared aminoplast resin solution at this point. This variant is shown in column b2 in table 1.

1.2 Concentration of the Modified Aminoplast Resin Solution or Suspension from 1.1

The experimental parameters of examples 1 to 18 for the concentration of the aminoplast resin are shown in table 2.

After the aminoplast resin synthesis, the methanol/water solvent mixture was separated from the aminoplast resin using two thin-film evaporators DSV1 and DSV2 connected in series, in vacuo (P_{DSV1}, P_{DSV2}) and with heating (T_{DSV1}, T_{DSV2}), and an aminoplast resin melt was obtained.

The input of aminoplast resin solution into the first thin-film evaporator DSV1 is designated in table 2 by m′₁, and the output of aminoplast resin melt from the second thin-film evaporator DSV2 by m′₂. This output from DSV2 corresponds to the input into the downstream extruder. The speed of DSV1 is stated as N_{DSV1} and the speed of DSV2 as n_{DSV2}.

According to the variant designated by column a3 in table 2, the transetherification agent Simulsol BPPE was metered into the thin-film evaporator DSV2 in experiments 13 and 17.

After the concentration, a modified substantially solvent-free aminoplast resin melt was obtained.

### 1.3 Reactive Conversion of the Modified Aminoplast Resin Melt

The modified, substantially solvent-free aminoplast resin melt from 1.2. was reactively converted in the downstream extrusion step. The experimental parameters are shown in table 3.

In examples 14 and 18, the transetherification agent Simulsol BPPE was added in the extrusion step. This variant is designated by column a4 in table 3.

In experiments 4, 9, 13, 14, 17 and 18, the Exolit AP 462 capsules were added in the extrusion step. This variant is designated by column b3 in table 3.

In experiments 3 and 8, the encapsulated compound Exolit AP 462 was likewise added in the extrusion step, where it was suspended in 50% by weight resin solution. In the table, this variant is shown in column ab1. The 50% by weight resin solution was, in accordance with the numbering of the examples, prepared from the corresponding resin solution from 1.1. Column ab1 is subdivided into the total mass flow [kg/h] (suspending agent+capsules) and the content of capsules [% by weight] in the suspension.

The extrusion was effected under a devolatilization vacuum P_{Extr}, an average temperature of the first 6 extruder barrels of T0₁₋₆, a material temperature of Tₘₐₜₑᵣᵢₐₗ and a screw speed n_{Extr}. The output of the extruder is stated as m′_{Extr}.

The extrudate of the aminoplast resin system according to the invention was cooled and granulated after extrusion. The product obtained comprised granules having a glass transition temperature T_{g} and a melt viscosity q.

The melt viscosity η was measured isothermally at 100 and 130° C. If a measurement was not possible at a temperature, it is characterized by “--”.

In table 3, the capsule content in % by weight, based on the total weight of the extrudate, is also shown.

The curing time in s, stated in the table, designates the duration which is required for a degree of curing of from 90 to 95% at the respective temperature. It is stated as “curing time [s]/curing temperature [° C.]”. From table 3, it is evident that, in the case of those aminoplast resin systems to which no encapsulated compounds were added (comparative experiments 5, 10, 11, 15), both the curing time is substantially longer and the required curing temperature is substantially higher in comparison with the aminoplast resin systems according to the invention which contain encapsulated compounds.

TABLE 1

| Preparation of the modified aminoplast resin solutions | | | | | | | | | | |
|---|---|---|---|---|---|---|---|---|---|---|
| | | | | | Transetherification | | | | | |
| | | | | | agent¹ | Capsules² | | | | Solids |
| Melamine | Formalin | CH₃OH | Molar ratio | p-TsOH | [kg] | [kg] | T_{React} | t_{Clear} | t_{React} | content |

| Ex. No. | [kg] | 37% [kg] | [kg] | F/M/CH₃OH | [kg] | a1 | a2 | b1 | b2 | [° C.] | [min] | [min] | [% by wt.] |
|---|---|---|---|---|---|---|---|---|---|---|---|---|---|
| 1 | 19.0 | 24.46 | 57.88 | 1/2/12 | 0.12 | — | — | 3.39 | — | 95 | — | 30* | 33.1 |
| 2 | 19.0 | 24.46 | 57.88 | 1/2/12 | 0.12 | — | — | — | 3.39 | 95 | 28 | 2 | 33.1 |
| 3 | 19.0 | 24.46 | 57.88 | 1/2/12 | 0.12 | — | — | — | — | 95 | 28 | 2 | 30.5 |
| 4 | 19.0 | 24.46 | 57.88 | 1/2/12 | 0.12 | — | — | — | — | 95 | 28 | 2 | 30.5 |
| 5 | 19.0 | 24.46 | 57.88 | 1/2/12 | 0.12 | — | — | — | — | 95 | 28 | 2 | 30.5 |
| 6 | 15.55 | 30.0 | 55.23 | 1/3/14 | 0.07 | — | — | 4.98 | — | 85 | — | 60* | 31.6 |
| 7 | 15.55 | 30.0 | 55.23 | 1/3/14 | 0.07 | — | — | — | 4.98 | 85 | 30 | 30 | 31.6 |
| 8 | 15.55 | 30.0 | 55.23 | 1/3/14 | 0.07 | — | — | — | — | 85 | 30 | 30 | 28.2 |
| 9 | 15.55 | 30.0 | 55.23 | 1/3/14 | 0.07 | — | — | — | — | 85 | 30 | 30 | 28.2 |
| 10 | 15.55 | 30.0 | 55.23 | 1/3/14 | 0.07 | — | — | — | — | 85 | 30 | 30 | 28.2 |
| 11 | 15.55 | 30.0 | 55.23 | 1/3/14 | 0.07 | 4.81 | — | — | — | 85 | 30 | 30 | 31.5 |
| 12 | 15.55 | 30.0 | 55.23 | 1/3/14 | 0.07 | 4.81 | — | — | 13.8 | 85 | 30 | 30 | 39.4 |
| 13 | 15.55 | 30.0 | 55.23 | 1/3/14 | 0.07 | — | — | — | — | 85 | 30 | 30 | 28.2 |
| 14 | 15.55 | 30.0 | 55.23 | 1/3/14 | 0.07 | — | — | — | — | 85 | 30 | 30 | 28.2 |
| 15 | 15.55 | 30.0 | 55.23 | 1/3/14 | 0.07 | 1.49 | — | — | — | 85 | 30 | 30 | 29.3 |
| 16 | 15.55 | 30.0 | 55.23 | 1/3/14 | 0.07 | 1.49 | — | — | 9.8 | 85 | 30 | 30 | 35.4 |
| 17 | 15.55 | 30.0 | 55.23 | 1/3/14 | 0.07 | — | — | — | — | 85 | 30 | 30 | 28.2 |
| 18 | 15.55 | 30.0 | 55.23 | 1/3/14 | 0.07 | — | — | — | — | 85 | 30 | 30 | 28.2 |

¹Simulsol BPPE
²Exolit AP 462
*Total reaction time

TABLE 2

| | Concentration of the modified aminoplast resin solutions | | | | | | | | |
|---|---|---|---|---|---|---|---|---|---|
| | m′₁ | T_{DSV1} | T_{DSV2} | P_{DSV1} | P_{DSV2} | Transetherification agent³ | n_{DSV1} | n_{DSV2} | m′ₐ |
| Ex. No. | [kg/h] | [° C.] | [° C.] | [mbar] | [mbar] | [kg/h] a3 | [rpm] | [rpm] | [kg/h] |
| 1 | 30 | 85 | 140 | 150 | 150 | — | 1400 | 400 | 9.9 |
| 2 | 30 | 85 | 140 | 150 | 150 | — | 1400 | 400 | 9.9 |
| 3 | 35 | 95 | 140 | 150 | 150 | — | 1400 | 400 | 10.7 |
| 4 | 35 | 95 | 140 | 150 | 150 | — | 1400 | 400 | 10.7 |
| 5 | 35 | 95 | 140 | 150 | 150 | — | 1400 | 400 | 10.7 |
| 6 | 30 | 90 | 140 | 150 | 150 | — | 1400 | 400 | 9.5 |
| 7 | 30 | 90 | 140 | 150 | 150 | — | 1400 | 400 | 9.5 |
| 8 | 35 | 105 | 140 | 150 | 150 | — | 1400 | 400 | 9.9 |
| 9 | 35 | 105 | 140 | 150 | 150 | — | 1400 | 400 | 9.9 |
| 10 | 35 | 105 | 140 | 150 | 150 | — | 1400 | 400 | 9.9 |
| 11 | 35 | 100 | 140 | 150 | 150 | — | 1400 | 400 | 11.0 |
| 12 | 25 | 85 | 140 | 150 | 150 | — | 1400 | 400 | 9.9 |
| 13 | 35 | 100 | 140 | 150 | 150 | 1.74 | 1400 | 400 | 11.6 |
| 14 | 35 | 100 | 140 | 150 | 150 | — | 1400 | 400 | 9.9 |
| 15 | 35 | 100 | 140 | 150 | 150 | — | 1400 | 400 | 10.3 |
| 16 | 30 | 95 | 140 | 150 | 150 | — | 1400 | 400 | 10.0 |
| 17 | 35 | 100 | 140 | 150 | 150 | 0.53 | 1400 | 400 | 10.4 |
| 18 | 35 | 100 | 140 | 150 | 150 | — | 1400 | 400 | 9.9 |

³Simulsol BPPE

TABLE 3

| | Reactive conversion of the modified aminoplast resin melts, properties of the granules | | | | | | | | | | | | |
|---|---|---|---|---|---|---|---|---|---|---|---|---|---|
| | | | | | | Transetherification | | | | | | | |
| | | | | | | agent⁴ | | | Cap- | | | | |
| | | | | | | | ab1 | | sules⁵ | | η [pa · s] | Curing time | |
| | T0₁₋₆ | Tₘₐₜₑᵣᵢₐₗ | P_{Extr} | n_{Extr} | m′_{Extr} | a4 | | % by | b3 | T_{g} | isothermally at | [s] at T | Capsules |
| Ex. No. | [° C.] | [° C.] | [mbar] | [rpm] | [kg/h] | [kg/h] | [kg/h] | wt. | [kg/h] | [° C.] | 100/130 [° C.] | [° C.] | [% by wt.] |
| 1 | 130 | 120 | 960 | 330 | 9.8 | — | — | — | — | 82 | 15 000/— | 80/150 | 10 |
| 2 | 140 | 130 | 960 | 330 | 9.8 | — | — | — | — | 71 | 10 000/— | 100/150 | 10 |
| 3 | 200 | 190 | 960 | 330 | 12.3 | — | 2.68⁶ | 49.6 | — | 52 | 500/— | 300/150 | 10 |
| 4 | 150 | 140 | 960 | 330 | 11.8 | — | — | — | 1.19 | 60 | 3000/— | 120/150 | 10 |
| 5 | 240 | 220 | 960 | 330 | 10.6 | — | — | — | — | 86 | —/5800 | 300/180 | — |
| 6 | 140 | 130 | 960 | 330 | 9.4 | — | — | — | — | 73 | 11 000/— | 90/150 | 16 |
| 7 | 150 | 140 | 960 | 330 | 9.4 | — | — | — | — | 65 | 8000/— | 100/150 | 16 |
| 8 | 210 | 200 | 960 | 330 | 12.5 | — | 4.06⁶ | 50.0 | — | 45 | 300/— | 500/150 | 15 |
| 9 | 170 | 155 | 500 | 330 | 11.55 | — | — | — | 1.75 | 58 | 20 000/1000 | 110/150 | 15 |
| 10 | 240 | 220 | 960 | 330 | 9.8 | — | — | — | — | 69 | —/70 | 530/180 | — |
| 11 | 250 | 230 | 300 | 330 | 10.7 | — | — | — | — | 50 | —/50 | 540/180 | — |
| 12 | 200 | 180 | 300 | 330 | 9.6 | — | — | — | — | 60 | 1500/— | 280/150 | 35 |
| 13 | 210 | 190 | 960 | 330 | 17.2 | — | — | — | 6.1 | 55 | 800/— | 360/150 | 35.5 |
| 14 | 210 | 190 | 960 | 330 | 18.1 | 2.7 | — | — | 6.1 | 53 | 300/— | 420/150 | 34 |
| 15 | 245 | 225 | 300 | 330 | 10.0 | — | — | — | — | 55 | —/100 | 500/180 | — |
| 16 | 190 | 170 | 300 | 330 | 9.7 | — | — | — | — | 64 | 2500/— | 240/150 | 28 |
| 17 | 200 | 180 | 960 | 330 | 13.9 | — | — | — | 3.9 | 61 | 1000/— | 310/150 | 28 |
| 18 | 200 | 180 | 960 | 330 | 14.3 | 0.7 | — | — | 4.1 | 58 | 500/— | 240/150 | 29 |

⁴Simulsol BPPE
⁵Exolit AP 462
⁶Suspending agent: 50% by weight resin solution

2 Production of a Pure Resin Sheet from the Modified Aminoplast Resin System

A pressed sheet having the dimensions of 100×100×3 mm was produced from the aminoplast resin system of experiments 4, 5, 9, 10, 11, 13, 15, 17 which was prepared in 1.

The tool used for this purpose was a laminate press. The granules were milled and the powder was then introduced into the stainless steel mold heated to 100° C. and melted for about 8 min at this temperature. Thereafter, the press tool was heated to 180° C., placed in the press at 180° C. for 30 min and pressed at 80 bar. The test specimen was then cooled to 70° C. in the press for a duration of about 15 min.

The pure resin sheet was removed from the mold at 70° C. Test bars for mechanical tests and for fire tests were produced from this pure resin sheet.

The fire test UL-94 is a test for determining the flammability of materials. The classification is effected according to fire classes V-0, V-1, V-2, n.p., where V-0 is the highest (best) fire class, i.e. the fire behavior fulfills all test criteria, and n.p. means not passed. The UL-94 test is carried out according to ASTM 2863, vertical.

The properties of the pure resin sheet are shown in table 4.

With regard to the fire tests, table 4 shows that the aminoplast resin systems according to the invention have excellent fire behavior. In the case of the etherified resins of experiments A, C, the best fire class V-0 was obtained; in the case of the transetherified resins F and H, it was possible to achieve the fire classes V-1 and V-2.

In comparison, the fire test was not passed by any of the capsule-free resins of experiments B, D, E and G.

From table 4, it is furthermore evident that there is no deterioration in the tensile strength and tensile elongation in comparison with the capsule-free (examples 5, 10, 11, 15) aminoplast resin systems as a result of the incorporation of the capsules according to the invention.

In the case of the transetherified resins from experiments E, F, G and H, it is also evident that a substantially higher diol conversion is achieved in the case of the capsule-containing resin systems according to the invention (experiments F and H) than in the case of the capsule-free resins (experiments E and G). A higher diol conversion results in lower emissions during the curing and in the end product.

In the volume contraction too, which is a measure of the shrinkage during curing, substantially lower values are obtained for the capsule-containing aminoplast resin systems according to the invention than in the case of the comparative resins.

### 3 Production of Natural Fiber Composites

The modified aminoplast resin system according to the invention of experiments 4, 5, 9, 10, 11, 13, 15, 17 from 1 was sprinkled onto a flax nonwoven fabric having a weight per unit area of 300-350 g/m² by means of a powder sprinkling unit, a resin coat of about 30% of the total weight being achieved.

The powder-coated nonwoven was then subjected to pre-condensation in an IR field at 190° C. for 2 min, after which 300×200 mm shapes were punched out. 6 layers of powder-coated nonwovens were then placed one on top of the other with the powder-coated side facing upward, and this pre-condensed fiber composite was placed in an evacuable downstroke molding press heated to 180° C.

After a pre-heating time of 30 sec, a pressure of 400 kN was applied for 20 sec in the first pressing stage, at the same time the vacuum being adjusted to 200 mbar absolute pressure. The venting was then effected for 20 sec in vacuo. In the second pressing stage, the fiber composite was pressed to a degree of curing of 95%, measured by means of ultrasound. The cured composite material was removed at 180° C.

The properties of the composite material are shown in table 5.

Substantial advantages of the aminoplast resin systems according to the invention over capsule-free resins (examples 5, 10, 11, 15) with regard to the fire behavior, the diol conversion, the volume contraction, the curing time and the impact resistance are evident therefrom.

TABLE 4
Properties of the pure resin sheets - resin test specimens without reinforcing fibers

| | | Capsule | UL-94 | Tensile | Tensile | Conversion | Mass loss during | Volume |
|---|---|---|---|---|---|---|---|---|
| | Resin from | content | 3 mm sheet | strength | elongation | diol | processing | contraction |
| Experiment | ex. no. | [% by wt.] | [—] | [MPa] | [%] | [%] | [% by wt.] | [%] |
| A | 4 | 10 | V-0 | 40 | 1.2 | — | 3.5 | 9 |
| B | 5 | — | n.p. | 35 | 1.5 | — | 4 | 10 |
| C | 9 | 15 | V-0 | 35 | 1.4 | — | 4 | 8 |
| D | 10 | — | n.p. | 30 | 1.6 | — | 5 | 9 |
| E | 11 | — | n.p. | 25 | 2.5 | 60 | 11 | 12 |
| F | 13 | 35.5 | V-2 | 35 | 1.5 | 85 | 3.5 | 9 |
| G | 15 | — | n.p. | 30 | 2.0 | 60 | 9 | 11 |
| H | 17 | 28 | V-1 | 35 | 1.3 | 80 | 3 | 9 |

TABLE 5
Properties of the fiber composites - resin test specimens with natural fiber reinforcement

| | | | Capsule | UL-94 | | | | Mass loss | | Curing | |
|---|---|---|---|---|---|---|---|---|---|---|---|
| | | Fiber | content | 3 mm | Tensile | Tensile | Conversion | during | Volume | time at | Impact |
| | Resin | content | in resin | sheet | strength | elongation | diol | processing | contraction | 180° C. | resistance |
| Experiment | no. | [%] | [% by wt.] | [—] | [MPa] | [%] | [%] | [% by wt.] | [%] | [sec] | [kJ/m²] |
| A1 | 4 | 70 | 10 | V-0 | 8000 | 3.5 | — | 1.9 | 1.0 | 180 | 28 |
| B1 | 5 | 70 | — | n.p. | 7800 | 3.0 | — | 2.1 | 2.5 | 370 | 25 |
| C1 | 9 | 70 | 15 | V-0 | 7900 | 3.3 | — | 2.5 | 1.3 | 240 | 30 |
| D1 | 10 | 70 | — | n.p. | 7800 | 3.1 | — | 2.2 | 2.9 | 420 | 23 |
| E1 | 11 | 70 | — | n.p. | 6000 | 4.5 | 65 | 3.0 | 3.5 | 600 | 20 |
| F1 | 13 | 70 | 35.5 | V-0 | 6200 | 5.1 | 95 | 3.2 | 1.5 | 260 | 26 |
| G1 | 15 | 70 | — | n.p. | 6800 | 4.0 | 60 | 2.6 | 3.0 | 530 | 22 |
| H1 | 17 | 70 | 28 | V-0 | 7000 | 4.6 | 93 | 2.8 | 2.6 | 290 | 28 |

1-28. (canceled)

29. A flame-resistant aminoplast resin system, comprising:
a) a modified aminoplast resin matrix having primary aminoplast condensates present at least partly in etherified form in the modified aminoplast resin, wherein the modified aminoplast resin is obtained from a substantially solvent-free aminoplast resin melt, and
b) at least one compound which contains at least one of phosphorus, nitrogen or boron in chemically bonded form and is present in encapsulated form and enclosed by a capsule wall material in the aminoplast resin matrix as a flame-retardant component, wherein the resin system produced is a melamine-formaldehyde resin system, a melamine/urea-formaldehyde resin system, or a formaldehyde resin system.

30. The aminoplast resin system as claimed in claim 29, wherein the aminoplast resin is etherified with C₁-C₄-alcohols.

31. The aminoplast resin system as claimed in claim 29, wherein the modified aminoplast resin contains at least one of transetherification agents, modifiers, fillers, reinforcing fibers, further polymers, stabilizers, UV absorbers, or auxiliaries.

32. The aminoplast resin system as claimed in claim 31, wherein the transetherification agents used are at least one of aliphatic C₄-C₁₈-alcohols, aromatic alcohols, diols, polyols or mixtures thereof.

33. The aminoplast resin system as claimed in claim 29, wherein the at least one compound present in encapsulated form contains ammonium polyphosphate, melamine polyphosphate, phosphoric acid ester and phosphonic acid ester based on the reaction of phosphorus pentoxide or phosphorus trioxide with pentaerythritol or dipentaerythritol, and ammonium and melamine salts thereof.

34. The aminoplast resin system as claimed in claim 29, wherein the at least one compound present in encapsulated form also has a proton-liberating effect in addition to the flame-retardant effect.

35. The aminoplast resin system as claimed in claim 29, wherein the system contains a plurality of different compounds present in encapsulated form.

36. The aminoplast resin system as claimed in claim 29, wherein the capsule wall material comprises a thermosetting resin selected from the group consisting of an aminoplast resin, an epoxy resin, an unsaturated polyester resin, and a phenol resin.

37. The aminoplast resin system as claimed in claim 36, wherein the capsule wall material comprises a modified aminoplast resin which has surface properties similar to the modified aminoplast resin forming the modified aminoplast resin matrix.

38. The aminoplast resin system as claimed in claim 29, wherein the at least one compound present in encapsulated form is present in homogeneously distributed form in the aminoplast resin matrix.

39. The aminoplast resin system as claimed in claim 29, wherein the ratio of diameter to capsule wall thickness of the capsules is from 5 to 1000.

40. The aminoplast resin system as claimed in claim 29, wherein the average diameter D of the capsules is in the range of 1-100 μm, such as 10-60 μm or 20-50 μm.

41. The aminoplast resin system as claimed in claim 29, wherein the geometrical shape of the capsules is spherical.

42. The aminoplast resin system as claimed in claim 29, wherein the amount of at least one compound present in encapsulated form is from 0.5 to 50% by weight, such as from 1 to 40% by weight or from 5 to 25% by weight, based on the total weight of the cured aminoplast resin system.

43. The aminoplast resin system as claimed in claim 29, wherein the amount of at least one compound present in the capsules is from 50 to 98% by weight, such as from 70 to 90% by weight, based on the total weight of a compound present in encapsulated form.

44. The aminoplast resin system as claimed in claim 29, wherein the at least one compound present in encapsulated form is added to the modified aminoplast resin as powder or as suspension or both.

45. The aminoplast resin system as claimed in claim 44, wherein the substantially solvent-free aminoplast resin melt or at least a part of the transetherification agents or modifiers used for modifying the aminoplast resin are used as suspending agents.

46. The aminoplast resin system as claimed in claim 44, wherein the solids content of the suspension is from 30 to 90% by weight, such as from 40 to 80% by weight, and the viscosity is from 10 to 5000 mPa·s, such as from 250 to 1000 mPa·s.

47. A process for the preparation of a flame-resistant aminoplast resin system, comprising the steps of:
a) preparing a modified aminoplast resin solution or aminoplast resin suspension from an aminoplast former, a carbonyl compound and a C₁-C₄-alcohol at a pH=2 to 7, a temperature of from 40 to 160° C., a pressure of from 0 to 5 bar and a reaction time of from 5 to 300 minutes,
b) concentrating the modified aminoplast resin solution or aminoplast resin suspension after the pH has been made alkaline by distilling off the solvent at from 50 to 180° C. and from −1 to 0 bar and in a residence time of from 1 to 120 minutes to give a substantially solvent-free aminoplast resin melt,
c) reacting the substantially solvent-free aminoplast resin melt at a temperature of from 130 to 250° C. and from −1 to 0 bar and in a residence time of from 0.5 to 10 minutes in an extruder or kneader for pre-condensation and conditioning,
d) adding at least one compound enclosed by a capsule wall material during or after at least one of steps a), b), or c), whereupon
e) the flame-resistant aminoplast resin system is compounded and discharged.

48. The process as claimed in claim 47, wherein at least one of transetherification agents or modifiers are added to the modified aminoplast resin during or after at least one of steps a), b), or c).

49. The process as claimed in claim 48, wherein the addition of at least one compound present in encapsulated form in the form of a suspension in the transetherification agents or modifiers or both is effected during the reactive conversion in an extruder.

50. The process as claimed in claim 47, wherein the reactive conversion is carried out in two extruders connected in series.

51. The preparation of hybrid resin systems having a flame-resistant aminoplast resin system as claimed in claim 29, comprising the step of mixing or chemical reaction or both the flame-resistant aminoplast resin systems with at least one of modified or unmodified melamine-formaldehyde resins, epoxy resins, polyurethane resins, unsaturated polyester resins or alkyd resins as melts in a kneader, mixer or extruder.

52. The preparation of hybrid resin systems having a flame-resistant aminoplast resin system as claimed in claim 29, wherein the resin is in the form of granules or powder or both as compression molding resin or as injection molding resin.

53. The preparation of hybrid resin systems having a flame-resistant aminoplast resin system as claimed in claim 29 for the production of a composite material, wherein a substrate material is coated with the flame-resistant aminoplast resin system in powder form or the aminoplast resin system is melted and the substrate material is drawn through the resin melt or both, whereupon a pre-condensation step in the range of about 110-250° C. for a duration of about 1-10 minutes is effected, whereupon the storable prepreg obtained is subjected to shaping with a temperature increase and is cured thereby.

54. The preparation of hybrid resin systems having a flame-resistant aminoplast resin system as claimed in claim 29, wherein the resin is used for pipes, sheets, profiles, injection molded parts or fibers, as a curing agent or crosslinking agent in powder coating systems or for the production of flame-resistant shaped articles.

55. A composite material having a substrate material coated with a flame-resistant aminoplast resin system as claimed in claim 29, wherein the resin is a coating in powder form or the aminoplast resin system is melted and the substrate material is drawn through the resin melt, whereupon a pre-condensation step in the range of about 110-250° C. for a duration of about 1-10 minutes is effected, whereupon the storable prepreg obtained is subjected to shaping with a temperature increase and is cured thereby.

56. The composite material as claimed in claim 55, wherein the shaping and curing are effected by a pressing process in an acidic pH range of pH 3-pH 6.5 at from 90 to 250° C. and from 10 to 250 bar compression pressure and for a duration of from 0.5 to 30 minutes.
